(19) United States
(12) Patent Application Publication
(10) Pub. No.: US 2012/0096477 A1
(43) Pub. Date: Apr. 19, 2012

(54) APPARATUS AND METHOD FOR PROVIDING VEHICLE INFORMATION

(75) Inventors: Shin-Kyung LEE, Daejeon (KR); Jeong-Woo LEE, Daejeon (KR); Oh-Cheon KWON, Suwon-si (KR)

(73) Assignee: Electronics and Telecommunications Research Institute, Daejeon (KR)

(21) Appl. No.: 13/271,762

(22) Filed: Oct. 12, 2011

(30) Foreign Application Priority Data
Oct. 13, 2010 (KR) 10-2010-0099978

(51) Int. Cl. G06F 9/44; G06F 17/30

(52) U.S. Cl. 719/328; 707/602

(57) ABSTRACT

An apparatus for providing vehicle information receives protocol information of an in-vehicle network, extracts a data analysis file corresponding to a protocol type among a plurality of pre-stored data analysis files, receives from the in-vehicle network, source data that contains a plurality of pieces of vehicle information, and extracts partial vehicle information from the source data according to the data analysis file.

### CROSS REFERENCE TO RELATED APPLICATION

This application claims the benefit of Korean Patent Application No. 10-2010-0099978, filed on Oct. 13, 2010, which is hereby incorporated by reference in its entirety into this application.

### BACKGROUND OF THE INVENTION

1. Technical Field

The present invention relates generally to an apparatus and method for providing vehicle information. More particularly, the present invention relates to an apparatus and method for extracting vehicle information in conjunction with an in-vehicle network, and providing the extracted vehicle information.

2. Description of the Related Art

Various platforms, such as an AUTomotive Open System Architecture (AUTOSAR), an auto platform, and an Open Service Gateway Initiative (OSGi) platform, can provide a flexible development environment by reusing the common parts of a single organization. However, such platforms not only make it impossible for them to be immediately applied to vehicles that are currently driving, but also make it difficult to obtain the effect of shortening a period required for the development or testing of services in medium- and small-sized businesses without spending extra expense.

Further, since vehicle manufacturing companies do not open information about the electronic systems of vehicles, it has been difficult for medium- and small-sized businesses to develop or test new services or functionality using vehicle information.

### SUMMARY OF THE INVENTION

The present invention has been made to provide an apparatus and method for processing vehicle information that can be collected via an in-vehicle network.

The present invention provides a method in which an apparatus extracts and provides the vehicle information, the method including: receiving initial setting information that contains protocol information of an in-vehicle network, extracting a data analysis file corresponding to the protocol information among a plurality of pre-stored data analysis files, receiving source data from the in-vehicle network that contains a plurality of pieces of vehicle information, and extracting partial vehicle information from the source data according to the data analysis file.

In accordance with another aspect of the present invention, there is provided an apparatus for providing vehicle information, including an information extraction unit and an application program execution unit. The information extraction unit receives source data of a vehicle from an in-vehicle network and extracts vehicle information from the source data according to a data analysis file. The application program execution unit executes a pre-stored application program using the vehicle information of the vehicle.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram showing the construction of an apparatus for providing vehicle information according to an embodiment of the present invention;

FIG. 2 is a diagram showing the construction of an information extraction unit according to an embodiment of the present invention;

FIG. 3 is a diagram showing the extractable information list of a data analysis file according to an embodiment of the present invention;

FIG. 4 is a diagram showing a list of APIs according to an embodiment of the present invention;

FIG. 5 is a diagram showing the structure of a data analysis file according to an embodiment of the present invention;

FIG. 6 is a flowchart showing a vehicle information provision method performed by an application program execution unit according to an embodiment of the present invention;

FIG. 7 is a flowchart showing a vehicle information provision method performed by an information extraction unit according to an embodiment of the present invention; and

FIG. 8 is a flowchart showing a vehicle information provision method performed by an in-vehicle network according to an embodiment of the present invention.

### DESCRIPTION OF THE PREFERRED EMBODIMENTS

The present invention will be described in detail below with reference to the attached drawings. In the specification, repeated descriptions may be omitted, and detailed descriptions of well-known functions or configurations that unnecessarily make the gist of the present invention obscure will also be omitted. The embodiments of the present invention are provided to describe the present invention more completely to those skilled in the art. Therefore, the shapes or sizes of components in the drawings may be exaggerated for the sake of providing a clearer description.

Hereinafter, an apparatus and method for providing vehicle information according to embodiments of the present invention will be described with reference to the attached drawings.

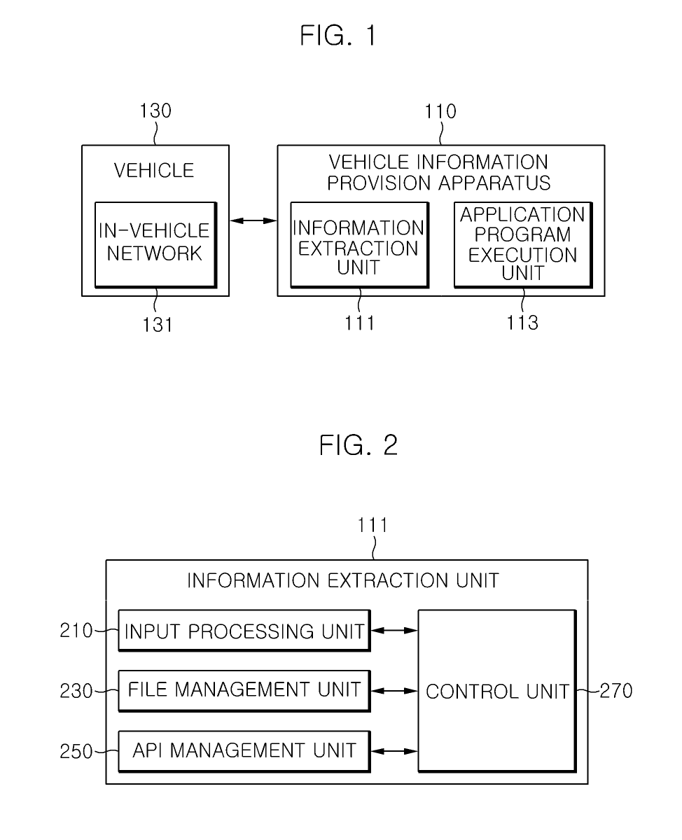

First, an apparatus for providing vehicle information according to an embodiment of the present invention will be described in detail with reference to FIG. 1.

FIG. 1 is a diagram showing the construction of an apparatus for providing vehicle information.

As shown in FIG. 1, an apparatus 110 for providing vehicle information receives source data containing various types of vehicle information in conjunction with an in-vehicle network 131 included in a vehicle 130, and extracts vehicle information desired to be used from the received source data. Here, the vehicle information provision apparatus 110 includes an information extraction unit 111 and an application program execution unit 113.

The information extraction unit 111 extracts vehicle information from the source data of the vehicle 130 received from the in-vehicle network 131 using a pre-stored data analysis file, and transfers the extracted vehicle information to the application program execution unit 113. In this case, the information extraction unit 111 may receive a request for the extraction of vehicle information from the application program execution unit 113 via a defined application program interface (hereinafter also referred to as an ‘API’.

The application program execution unit 113 requests and receives the vehicle information of the vehicle 130 from the information extraction unit 111, and executes an application program. Here, the application program execution unit 113 may request the extraction of the vehicle information from the information extraction unit 111 using the defined API. Further, the application program execution unit 113 may previously store the initial setting information of the vehicle 130, containing information about the manufacturing company of the vehicle 130, the type (model) of the vehicle 130, and the protocol of the in-vehicle network 131.

Next, the construction of the information extraction unit according to an embodiment of the present invention will be described with reference to FIG. 2.

FIG. 2 is a diagram showing the construction of the information extraction unit according to an embodiment of the present invention.

As shown in FIG. 2, the information extraction unit 111 includes an input processing unit 210, a file management unit 230, an application program interface management unit (hereinafter referred to as an ‘API management unit’) 250, and a control unit 270.

The input processing unit 210 receives the initial setting information of the vehicle 130 and a list of vehicle information to be extracted (hereinafter also referred to as an ‘extraction target information list’) from the source data of the vehicle 130. Here, the initial setting information of the vehicle 130 contains information about the manufacturing company of the vehicle 130, the type (model) of the vehicle 130, and the protocol of the in-vehicle network 131. In this case, the input processing unit 210 can receive the initial setting information of the vehicle 130 from the user through a plug-in program, the window of a browser, a text file or the like, and can also receive the initial setting information of the vehicle 130 from the application program execution unit 113.

The file management unit 230 stores a plurality of data analysis files determined according to manufacturing company information, vehicle model information and protocol information. Here, each of the data analysis files includes a list of vehicle information that is extractable (hereinafter also referred to as an ‘extractable information list’) from source data and the structure information of the source data.

The API management unit 250 stores member functions required to support APIs provided by the information extraction unit 111 to the application program execution unit 113.

The control unit 270 extracts a data analysis file corresponding to the initial setting information of the vehicle 130 from the file management unit 230, extracts the vehicle information of the vehicle 130 corresponding to the extraction target information list using the extracted data analysis file, and transfers the extracted vehicle information of the vehicle 130 to the application program execution unit 113. In this case, when the application program execution unit 113 requests the extraction of vehicle information via a preset API, the control unit 270 can extract the vehicle information of the vehicle 130 from the source data using a member function corresponding to the preset API.

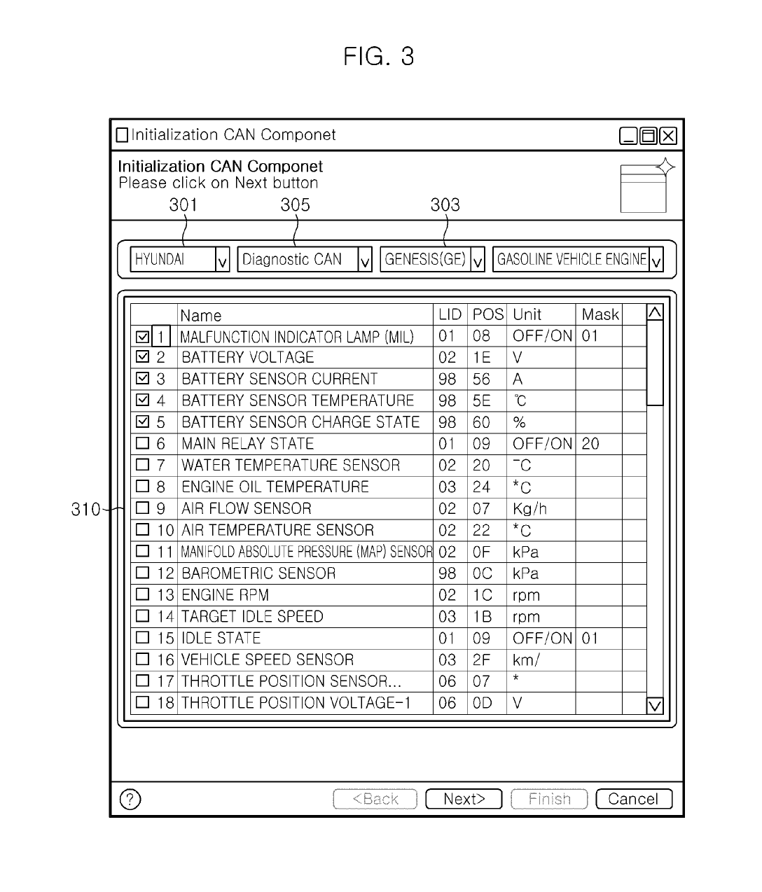

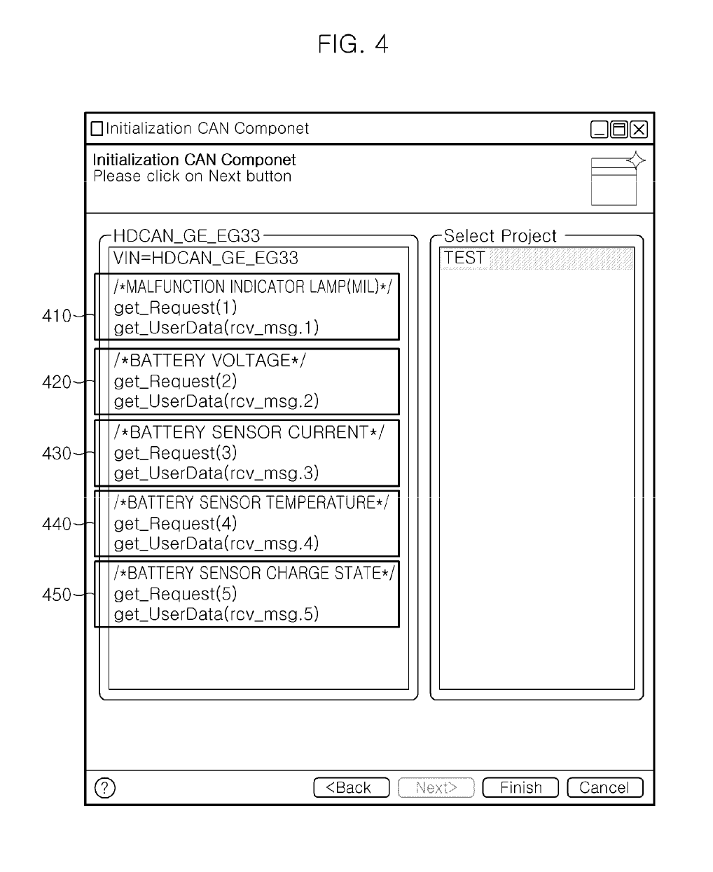

Hereinafter, the data analysis files stored in the vehicle information provision apparatus according to an embodiment of the present invention will be described with reference to FIG. 3.

FIG. 3 is a diagram showing the extractable information list of a data analysis file according to an embodiment of the present invention.

As shown in FIG. 3, when initial setting information includes information containing “HYUNDAI” corresponding to manufacturing company information 301, “GENESIS (GE)” corresponding to vehicle model information 303, and “Diagnostic CAN” corresponding to protocol information 305, the vehicle information provision apparatus 110 can extract a data analysis file corresponding to the relevant initial setting information from the file management unit 230, and can output an extractable information list 310 included in the extracted data analysis file.

In this case, a user selects from the output extractable information list 310 vehicle information to be extracted, thus enabling the vehicle information provision apparatus 110 to receive an extraction target information list.

Next, a list of APIs provided by the vehicle information provision apparatus according to an embodiment of the present invention will be described below with reference to FIG. 4.

FIG. 4 is a diagram showing a list of APIs according to an embodiment of the present invention.

As shown in FIG. 4, the vehicle information provision apparatus 100 can provide APIs corresponding to “malfunction indicator lamp (MIL)”, “battery voltage”, “battery sensor current”, “battery sensor temperature”, and “battery sensor charge state”.

The vehicle information provision apparatus 100 can support a first API 410 corresponding to “malfunction Indicator lamp (MIL)” using member functions “get_Request(1)” and “get_UserData(rcv_msg. 1)”.

The vehicle information provision apparatus 100 can support a second API 420 corresponding to “battery voltage” using member functions “get_Request(2)” and “get_UserData(rcv_msg. 2)”.

The vehicle information provision apparatus 100 can support a third API 430 corresponding to “battery sensor current” using member functions “get_Request(3)” and “get_UserData(rcv_msg. 3)”.

The vehicle information provision apparatus 100 can support a fourth API 440 corresponding to “battery sensor temperature” using member functions “get_Request(4)” and “get_UserData(rcv_msg. 4)”.

The vehicle information provision apparatus 100 can support a fifth API 450 corresponding to “battery sensor charge state” using member functions “get_Request(5)” and “get_UserData(rcv_msg. 5)”.

In this case, the vehicle information provision apparatus 100 can store member functions of Table 1 so as to provide the APIs.

TABLE 1

| Function name | Description |
|---|---|
| get_Request(no) | Create request message of selected (no) by the user |
| get_Data(stRcv,no) | Return value of information (no) selected by the user |
| | from received message(stRcv) |
| Get_DTC_Request(void) | Create DTC request message of a vehicle model selected |
| | by the user |
| Get_DTC_Data(stRcv) | Return DTC code of the vehicle model selected by the |
| | user from received message(stRcv) |
| get_OBD2_Request(PID) | Create Request message about supportable PIDs |
| | (Mode = 01) of OBD2 |
| get_OBD2_Data(stPid,stMulRcv,index) | Return only a response to information (index) selected by |
| | the user among the supportable PIDs of OBD2 from |
| | received multiple message(stMulRcv) |
| get_OBD2_DTC_Request(void) | Create DTC request message of (Mode = 03) of OBD2 |
| | information |
| get_OBD2_DTC_Data(stMulRcv) | Return collected DTC codes of OBD2 from received |
| | multiple message(stMulRcv) |

In Table 1, OBD denotes on board diagnostics, and DTC denotes diagnostic trouble code information.

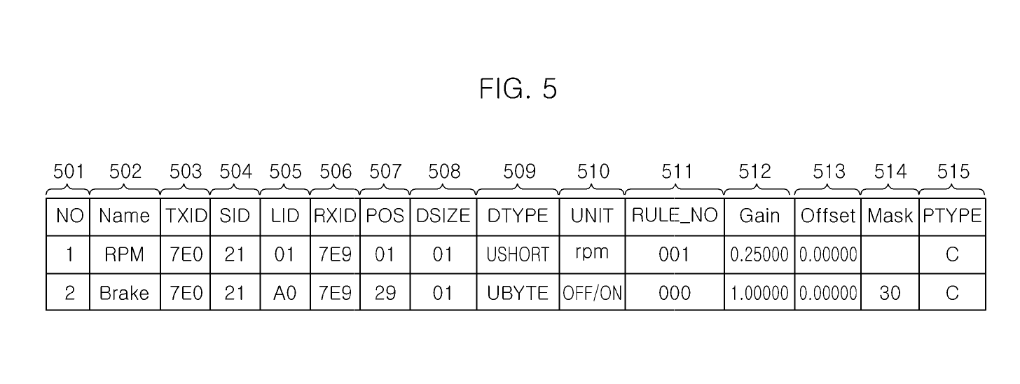

Next, the structure of the data analysis file of the vehicle information provision apparatus according to an embodiment of the present invention will be described in detail with reference to FIG. 5.

FIG. 5 is a diagram showing the structure of a data analysis file according to an embodiment of the present invention.

As shown in FIG. 5, the data analysis file includes a plurality of variables, that is, “NO”, “Name”, “TXID”, “SID”, “LID”, “RXID”, “POS”, “DSIZE”, “DTYPE”, “UNIT”, “RULE_NO”, “Gain”, “Offset”, “Mask”, and “PTYPE”.

A first variable 501, that is, “NO” denotes a unique number of vehicle information that can be extracted from the data analysis file of a relevant vehicle model and can be changed by the user.

A second variable 502, that is, “Name” denotes the name of vehicle information corresponding to “NO”.

A third variable 503, that is, “TXID” denotes the CAN(Controller Area Network) ID of the in-vehicle network 131 when the in-vehicle network 131 is a CAN, the third variable 503 being ECU (Electronics Control Unit) specific ID that is utilized as requested when a diagnostic CAN protocol is used.

A fourth variable 504, that is, “SID” denotes service ID.

A fifth variable 505, that is, “LID” denotes local ID.

In this case, when both “SID” and “LID” are “00”, the API management unit 250 determines relevant information to be information about a vehicle CAN (hereinafter referred to as a “Broadcast CAN”), and is then capable of invoking and using an API that processes only responses. Further, when a value other than “00” is present in “SID” and “LID,” the API management unit 250 can invoke and use an API for creating a request message for the in-vehicle network 131 and an API for processing a response to the request message.

A sixth variable 506, that is, “RXID” denotes ID used when making a response in the case where a diagnostic CAN protocol is used using the ID of the in-vehicle network 131.

A seventh variable 507, that is, “POS” denotes the location (or position) information of vehicle information corresponding to “NO” of source data.

An eighth variable 508, that is, “DSIZE” denotes the data size of vehicle information.

A ninth variable 509, that is, “DTYPE” denotes the data type of vehicle information.

A tenth variable 510, that is, “UNIT” denotes the unit of data indication of vehicle information.

An eleventh variable 511, that is, “RULE_NO” denotes processing rules for information that is provided in the form of on/off and information that is applied to a transformation formula (Data*gain+Offset). Here, the user can define new “RULE NO” and use separate functions so as to process pieces of collected vehicle information in different manners. In this case, the control unit 270 can process the vehicle information according to “RULE_NO”.

For example, when “RULE_NO” is “000”, the vehicle information can be indicated as the ON/OFF of state information. Further, when “RULE_NO” is “001”, the vehicle information can be calculated using a transformation formula on the source data.

A twelfth variable 512, that is, “Gain” denotes a gain value for the transformation of vehicle information.

A thirteenth variable 513, that is, “Offset” denotes an offset value for the transformation of vehicle information.

A fourteenth variable 514, that is, “Mask” denotes a bit mask value required to extract vehicle information in units of a bit from the source data.

A fifteenth variable 515, that is, “PTYPE” denotes the protocol type of the in-vehicle network 131. Here, “CAN Protocol” can be indicated as “C”, “K-Line” can be indicated as “K”, “LIN” can be indicated as “L”, and “FlexRay” can be indicated as “F”. Here, the extension of a structure is possible to provide an optimized data analysis file corresponding to “PTYPE”.

When the in-vehicle network 131 conforms to the same protocol, the source data of the in-vehicle network 131 has the same frame structure, but the structures of data fields in the frame may be defined differently according to the models of vehicles of respective manufacturing companies. Therefore, in order to utilize vehicle information, a data analysis file enabling the analysis of data fields is required.

In this way, the structure of the data analysis file shown in FIG. 5 is used, so that the costs and time required for the development of application services using vehicle information can be reduced, and the quality of application services can be improved.

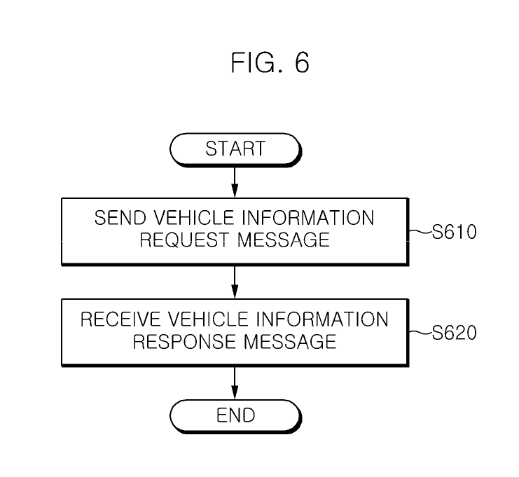

Hereinafter, a vehicle information provision method performed by the application program execution unit according to an embodiment of the present invention will be described with reference to FIG. 6.

FIG. 6 is a flowchart showing a vehicle information provision method performed by the application program execution unit according to an embodiment of the present invention.

As shown in FIG. 6, the application program execution unit 113 sends to the information extraction unit 111 vehicle information request message that is requesting the vehicle information of the vehicle 130 at step S610. In this case, the vehicle information request message may include an extraction target information corresponding to a list of vehicle information to be extracted from the source data of the vehicle 130.

Next, the application program execution unit 113 receives from the information extraction unit 111 a vehicle information response message including the vehicle information of the vehicle 130 at step S620.

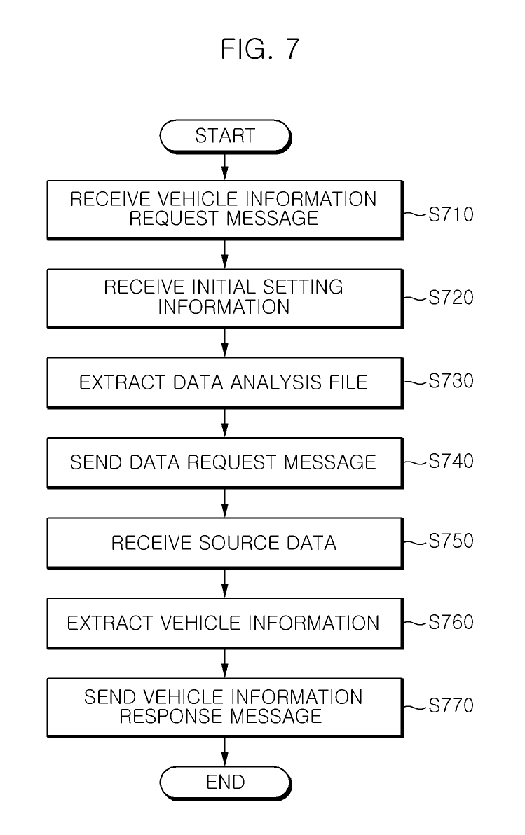

Hereinafter, a vehicle information provision method performed by the information extraction unit according to an embodiment of the present invention will be described with reference to FIG. 7.

FIG. 7 is a flowchart showing a vehicle information provision method performed by the information extraction unit according to an embodiment of the present invention.

As shown in FIG. 7, the information extraction unit 111 receives from the application program execution unit 113 a vehicle information request message that is requesting the vehicle information of the vehicle 130 at step S710. In this case, the vehicle information request message may include an selected targets information corresponding to a list of vehicle information to be extracted from the source data of the vehicle 130.

Thereafter, the information extraction unit 111 receives from the user the initial setting information of the vehicle 130 which contains the manufacturing company information of the vehicle 130, the vehicle model information of the vehicle 130, and the protocol information of the in-vehicle network 131 at step S720.

Next, the information extraction unit 111 extracts related data analysis file corresponding to the initial setting information of the vehicle 130 among a plurality of data analysis files which have been previously stored according to the received initial setting information of the vehicle 130 at step S730.

Thereafter, the information extraction unit 111 sends to the in-vehicle network 131 a data request message that is requesting the source data of the vehicle 130 at step S740.

Next, the information extraction unit 111 receives the source data of the vehicle 130, containing a plurality of pieces of vehicle information, from the in-vehicle network 131 at step S750.

Thereafter, the information extraction unit 111 extracts the vehicle information of the vehicle 130, corresponding to the extraction target information, from the received source data of the vehicle using the extracted data analysis file at step S760.

Next, the information extraction unit 111 sends to the application program execution unit 113 a vehicle information response message including the extracted vehicle information of the vehicle 130 at step S770. (e.g.; 70 rpm, 80 km/h, 75′C).

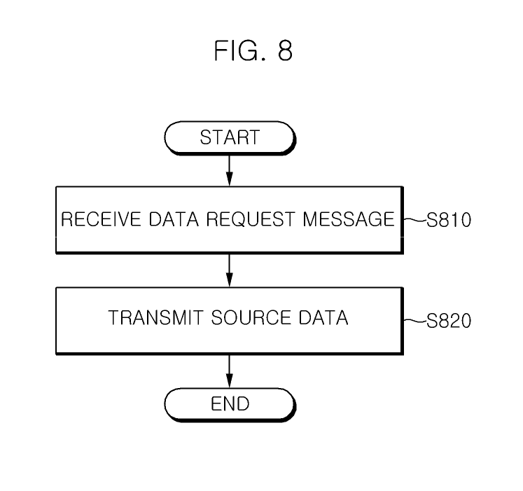

Hereinafter, a vehicle information provision method performed by the in-vehicle network according to an embodiment of the present invention will be described with reference to FIG. 8.

FIG. 8 is a flowchart showing a vehicle information provision method performed by the in-vehicle network according to an embodiment of the present invention.

As shown in FIG. 8, the in-vehicle network 131 receives from the information extraction unit 111 a data request message that is requesting the source data of the vehicle 130 at step S810.

Next, the in-vehicle network 131 transmits to the information extraction unit 111 the source data of the vehicle 130 including the plurality of pieces of vehicle information in response to the received data request message at step S820.

According to the present invention, the following advantages can be predicted.

There is an advantage in that a data analysis file according to the protocol of an in-vehicle network is provided, so that costs and time required for the development of application services using vehicle information collected over the in-vehicle network can be reduced, and the quality of the application services can be improved.

Further, there is an advantage in that only a part of vehicle information contained in source data can be extracted using a data analysis file including the locations and sizes of respective pieces of vehicle information.

Furthermore, there is an advantage in that data analysis files corresponding to vehicle models of respective manufacturing companies are provided, so that medium- and small-sized businesses that are not the manufacturing companies of vehicles can develop or test new services and functionality using vehicle information.

As described above, optimal embodiments have been disclosed in the drawings and the specification. Here, although specific terms have been used, these are only used to describe the present invention and are not used to limit the meanings of the terms and scope of the present invention as described in the claims. Therefore, those skilled in the art will appreciate that various modifications and equivalent other embodiments are possible from the above description. Accordingly, the technical scope of the present invention should be defined by the spirit of the accompanying claims.

What is claimed is:

1. A method of providing vehicle information, comprising:
receiving initial setting information that contains protocol information of an in-vehicle network;
extracting a data analysis file corresponding to the protocol information among a plurality of pre-stored data analysis files;
receiving from the in-vehicle network, source data that contains a plurality of pieces of vehicle information; and
extracting partial vehicle information from the source data according to the data analysis file.

2. The method of claim 1, wherein the data analysis file comprises:
information about a location of each of the plurality of pieces of vehicle information in the source data; and
a data size of each of the plurality of pieces of vehicle information.

3. The method of claim 2, wherein the initial setting information further comprises manufacturing company information and vehicle model information.

4. The method of claim 3, wherein the data analysis file comprises a list of pieces of vehicle information that are extractable from the source data according to the manufacturing company information, the vehicle model information, and the protocol information.

5. The method of claim 4, further comprising:
receiving a list of pieces of vehicle information to be extracted from the source data in the list of pieces of vehicle information that are extractable; and
extracting vehicle information corresponding to the list of the pieces of vehicle information to be extracted from the source data according to the data analysis file.

6. The method of claim 5, further comprising:
displaying the list of pieces of vehicle information that are extractable before receiving the list of the pieces of vehicle information to be extracted.

7. An apparatus for providing vehicle information, comprising:
an information extraction unit for receiving source data of a vehicle from an in-vehicle network, and extracting vehicle information of the vehicle from the source data according to a data analysis file corresponding to the source data among a plurality of pre-stored data analysis files; and
an application program execution unit for executing a pre-stored application program using the vehicle information of the vehicle.

8. The apparatus of claim 7, wherein the information extraction unit comprises:
an input processing unit for receiving initial setting information that contains information about a manufacturing company of the vehicle, a model of the vehicle, and a protocol of the in-vehicle network; and
a control unit for extracting the data analysis file corresponding to the initial setting information from the plurality of data analysis files and extracting the vehicle information of the vehicle from the source data according to the extracted data analysis file.

9. The apparatus of claim 8, wherein the data analysis file comprises:
an extractable information list corresponding to a list of pieces of vehicle information that are extractable from the source data; and
structure information of the source data.

10. The apparatus of claim 9, wherein the structure information of the source data comprises information about a location in the source data, a data size and a processing rule of each of the pieces of vehicle information included in the extractable information list.

11. The apparatus of claim 10, wherein the control unit calculates and indicates the vehicle information of the vehicle using a preset transformation formula according to the information processing rule.

12. The apparatus of claim 7, wherein the application program execution unit requests extraction of the vehicle information to the information extraction unit via a preset application program interface (API).

13. The apparatus of claim 12, wherein the information extraction unit comprises a storage unit for storing a plurality of model functions that support the application program interface.
